(19) United States
(12) Patent Application Publication
(10) Pub. No.: US 2025/0096495 A1
(43) Pub. Date: Mar. 20, 2025

(54) COMBINATION SOCKET

(71) Applicant: DongGuan AHOKU Techland Electronics Ltd., DongGuan City (CN)

(72) Inventors: KUANG HAO LEE, DongGuan City (CN); Ming Tsai Wang, DongGuan City (CN); Chi Chu, DongGuan City (CN); Wei Chi Chih, DongGuan City (CN)

(21) Appl. No.: 18/467,680

(22) Filed: Sep. 14, 2023

(30) Foreign Application Priority Data
Dec. 12, 2022 (CN) 202211588032.9

(51) Int. Cl. H01R 13/11; H01R 13/05; H01R 13/639; H01R 27/02

(52) U.S. Cl. CPC H01R 13/113; H01R 13/05; H01R 13/639; H01R 27/02

(57) ABSTRACT

a combination socket comprises a socket surface that can accommodate multiple different specifications of IEC plugs. This socket surface has recessed grooves, socket cores, and socket holes; the surface of the socket core is equipped with live wire socket holes, neutral wire socket holes, and ground wire socket holes; the grooves include a wide groove located in front of the socket core and a narrow groove located behind the socket core. The narrow groove acts as a positioning guide when the first plug and the second plug are inserted, and the width of the narrow groove matches the thickness of the insulating wall of the first and second plugs; both the live wire socket hole and the neutral wire socket hole are cross-shaped socket holes; when the first plug or the second plug is inserted into the socket core, and the narrow groove fits with the insulating wall of the first plug or the second plug, allowing the first plug or the second plug to smoothly enter, and the narrow groove tightly secures the insulating wall of the first plug or the second plug, eliminating the need for independent anti-detachment parts, and not increasing the manufacturing cost.

### TECHNICAL FIELD

The present invention pertains to the field of socket technology, specifically to a combination socket.

### BACKGROUND ART

A Chinese invention disclosed under announcement number CN211428413U reveals a combination socket composed of IEC C13 and IEC C19 plug holes. In other words, this combination socket can accommodate IEC C14 and IEC C20 plugs of two different specifications. The fire neutral line (i.e., live and neutral lines) plug holes of this product are all T-shaped, designed for the insertion of two different types of IEC plugs (C14 and C20).

There are two drawbacks to the aforementioned combination socket:

First Drawback: The C14 and C20 plugs have different plug pin directions, resulting in different sizes. Specifically, the size of the C20 plug is larger than the C14 plug, and they have different end styles. The CN211428413U patent illustration shows the form for the C20 plug in FIG. 2 and for the C14 plug in FIG. 4. In other words, when replacing the C14 plug, the grooves formed between the protrusions and the inner wall of the shell are essentially equal in size. When the C14 plug is inserted into this combination socket, the outer insulation wall of the C14 isn't restricted in any way, resulting in a high degree of freedom of movement, rendering it impossible to directly fasten the C14 plug. An independent anti-off piece must be fitted, which not only increases the manufacturing cost but also is inconvenient for assembly and use.

Second Drawback: The conductive copper piece designed in the aforementioned combination socket consists of three copper sheets, forming a T-shaped slot with the plug holes. This makes the conductive copper piece come into three-point contact with the plug pins. However, since the conductive copper piece cannot perfectly parallel the plug pins, it only results in three-point contact. Because the conductive copper piece that provides the clamping force does not have reinforcing ribs, it exhibits insufficient clamping force. The conductive capacity of the socket depends on these two factors: the number of contact points and the clamping force.

In light of these issues, the inventor presents the following technical scheme to improve the design deficiencies of the aforementioned invention CN211428413U.

### SUMMARY

The purpose of this invention is to overcome the shortcomings of existing technology by providing a combination socket.

To solve the first technical problem mentioned, the following technical solution is adopted by the invention: This combination socket has a socket face on the shell of the combination socket, capable of accommodating various IEC plug standards. The socket face features a recessed groove, a socket core, and socket holes. The area recessed along the edge of the socket face is defined as the groove, and the area enclosed by the groove is the socket core.

The surface of the socket core has three socket holes: one for the live wire, one for the neutral wire, and one for the ground wire. The locations of the three socket holes correspond to the conductive pins of the first and second plugs. Beneath the socket holes, there are conductive contact sheets designed to engage with the pins of either the first or second plug.

The groove includes a wider front and narrower back located in front of and behind the socket core, respectively. The narrow groove acts as a positioning guide for the insertion of the first and second plugs, and the width of the narrow groove matches the thickness of the insulation wall of the plugs.

The live wire and neutral wire socket holes consist of vertical and horizontal rectangular holes intersecting in a cross shape. The neutral wire socket hole is symmetrically distributed with the live wire socket hole.

The conductive pin cross-section of the first plug is a vertical rectangle, conforming to either an IEC C14 or C16 plug. The conductive pin cross-section of the second plug is a horizontal rectangle, fitting an IEC C20 or C22 plug.

When the first plug is inserted into the socket core, the narrow groove aligns with the insulation wall of the first plug, permitting smooth insertion of the conductive pin into the vertical rectangular hole. Moreover, the narrow groove secures the insulation wall of the first plug.

When the second plug is inserted into the socket core, the narrow groove accommodates the insulation wall of the second plug, facilitating the conductive pin's insertion into the horizontal rectangular hole. The narrow groove also secures the insulation wall of the second plug.

Further, in the above technical solution, the conductive contact pieces beneath the live and neutral wire socket holes are both called live-neutral conductive contact pieces. The conductive pins in both the first and second plugs that correspond to the live and neutral wire socket holes are called live-neutral conductive pins. The live-neutral conductive contact piece has two opposing U-shaped contact pieces, with each U-shaped contact piece having a left and right wing. These wings act as reinforcing ribs to increase the holding force of the two opposing U-shaped contact pieces. Two opposing U-shaped contact pieces form a sleeve in the middle, with the left wing of one U-shaped contact piece and the right wing of another forming a first gap. The right wing of one U-shaped contact piece and the left wing of another form a second gap. The first and second gaps allow for the insertion of the live-neutral conductive pin of the second plug and are clamped by the left and right wings of the two U-shaped contact pieces, forming four contact points. The sleeve, however, allows for the insertion of the live-neutral conductive pin of the first plug and clamps it.

Further, in the above technical solution, the conductive contact piece under the ground wire socket hole is called the ground wire conductive contact piece. The conductive pin in both the first and second plugs that corresponds to the ground wire socket hole is called the ground wire conductive pin. A vertical rectangular hole is opened in the socket core that matches the position and size of the ground wire conductive pin of the first plug. A horizontal rectangular hole is also opened in the socket core to match the position and size of the ground wire conductive pin of the second plug. The vertical and horizontal rectangular holes overlay to form a T-shaped ground wire socket hole.

The ground wire conductive contact piece has a central arm, left and right wing arms bent from the two ends of the central arm, and left and right clip arms bent inwards from the side faces of the left and right wing arms. The faces of the left and right clip arms opposing each other are called the clip arm front faces, and the faces of the left and right clip arms opposing the central arm are called the clip arm blade faces. When the first plug is inserted into the socket core, the front faces of the left and right clip arms clamp the ground wire conductive pin of the first plug, and the central arm also contacts the other side of this ground wire conductive pin. This forms a three-face contact to increase the current capacity of the conduction. When the second plug is inserted into the socket core, the central arm and the blade faces of the left and right clip arms clamp the ground wire conductive pin of the second plug, also forming a three-face contact.

Further, in the above technical solution, an opening is set adjacent to the ground wire socket hole and the wide groove, allowing the ground wire socket hole and the wide groove to communicate, thus providing enough space for the deformation of the central arm.

Further, in the above technical solution, a vertical wall is set at the bottom of the wide groove, dividing the wide groove into a front groove and a back groove. The width of the front groove matches the thickness of the insulation wall of the second plug, and the width of the back groove matches the thickness of the insulation wall of the first plug. When the first plug is inserted into the socket core, the back groove and the narrow groove guide the first plug into the socket core, and the rear sidewall of the vertical wall is on the outside of the insulation wall of the first plug, fastening it. When the second plug is inserted into the socket core, the front groove and the narrow groove guide the second plug into the socket core, and the front sidewall of the vertical wall is inside the insulation wall of the second plug, securing it.

Further, in the above technical solution, the rear sidewall of the vertical wall is equipped with one or more rear protrusions. The top of the rear protrusion is equipped with a guide angle or round corner to allow the insertion of the insulation wall of the first plug. When the first plug is inserted into the socket core, the vertical wall is on the outside of the insulation wall of the first plug, and the rear protrusion tightly clings to the outside of the insulation wall of the first plug to secure it.

Further, in the above technical solution, the front sidewall of the vertical wall is equipped with one or more front protrusions. The top of the front protrusion is equipped with a guide angle or round corner to allow the insertion of the insulation wall of the second plug. When the second plug is inserted into the socket core, the vertical wall is inside the insulation wall of the second plug, and the rear protrusion tightly clings to the inside of the insulation wall of the second plug to secure it.

To elaborate, the technical solution mentioned above includes a lock cover that is separate from the combination socket. This lock cover is a semi-enclosed structure with a flat body. On top of the flat body, there is an unlock button and a protruding eave. On both sides of the unlock button, there is a downward groove, forming a connecting rod beneath the unlock button that can sway back and forth. This connecting rod also has an opening. When the first plug is inserted into the socket core, the flat body of the lock cover fits into the aforementioned front groove. The protruding eave of the lock cover rests on the platform of the first plug. The opening of the connecting rod latches onto the front protrusion of the vertical wall, securing the first plug in place. When the unlock button is pushed forward, the opening disengages from the protrusion on the vertical wall.

By adopting the above technical solution, the present invention has the following beneficial effects compared with the prior art:

1. The invention divides the groove into wide and narrow groove, and the hot line and neutral line sockets are set to be cross-shaped. The narrow groove serves as the positioning guide for the first and second plugs. The width of the narrow groove matches the thickness of the insulation wall of both plugs, effectively restricting the degree of freedom of the first and second plugs. The narrow groove can guide and position the insulation wall of the plugs. This achieves a tight fit for different plugs without the need to add independent anti-detachment parts, which not only avoids increasing manufacturing cost but also facilitates assembly and use.

2. The upper end of the live neutral line conductive contact piece in the invention is designed as two opposing U-shaped contact pieces. The left and right wings of the two U-shaped contact pieces serve as conductive contact points and reinforcing ribs for gripping strength. They not only enhance the gripping strength but also firmly hold the live neutral conductive pin of the second plug and form four contact points to enhance conductivity. The sleeve formed between the two opposing U-shaped contact pieces allows the live neutral conductive pin of the first plug to be inserted and gripped, ensuring stable conduction.

3. The ground socket hole set up by the invention is connected to the wide groove, which provides the central arm with more freedom to deform when the ground conductive pin is inserted, making the insertion of the ground conductive pin easier. After the ground conductive pin is pulled out, the ground conductive contact piece rebounds completely, further ensuring the durability and enhancing the lifespan of use.

4. The combination socket of this invention also includes an independent lock cover, which prevents some devices' power cords from being pulled and causing the first plug to fall out of the socket core.

### BRIEF DESCRIPTION OF THE DRAWINGS

FIG. 1 is a perspective view of the first plug;

FIG. 2 is a perspective view of the second plug;

FIG. 3 is a main view of the casing in the present invention;

FIG. 4 is a perspective view of the casing in the present invention;

FIG. 5 is an exploded view of the present invention;

FIG. 6 is a main view of the live-neutral line conductive contact piece in the present invention;

FIG. 7 is a main view of the ground conductive contact piece in the present invention;

FIG. 8 is a main view of the casing in the present invention after the addition of the vertical wall;

FIG. 9 is a perspective view of the casing in the present invention after the addition of the vertical wall;

FIG. 10 is an assembly diagram of the present invention with the first plug;

FIG. 11 is an assembly diagram of the present invention with the second plug;

FIG. 12 is a perspective view of the lock cover compatible with the present invention;

FIG. 13 is an assembly diagram of the present invention with the first plug and lock cover.

### DETAILED DESCRIPTION OF THE EMBODIMENTS

The invention will be further illustrated in conjunction with specific embodiments and accompanying drawings.

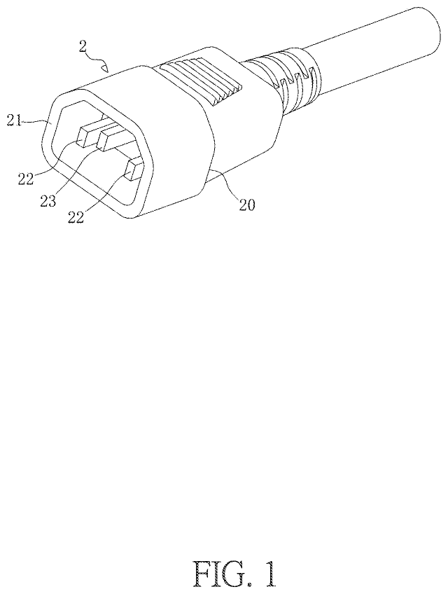

As shown in FIGS. 1-13, this is a combination socket 1, which has a socket face 10 suitable for the insertion of various different specifications of IEC plugs, that is to say, the combination socket 1 is suitable for various different specifications of IEC plugs, making it more convenient to use.

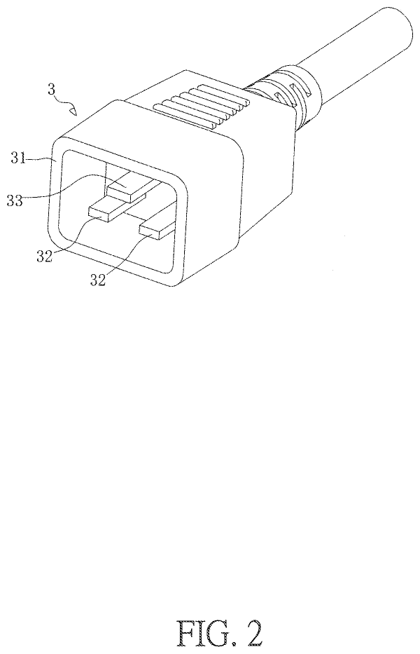

First, the first plug 2 and the second plug 3 are positioned. The conductive pin cross-section of the first plug 2 is a vertical rectangle, belonging to the IEC C14 plug or IEC C16 plug, as shown in FIG. 1. The conductive pin cross-section of the second plug 3 is a horizontal rectangle, belonging to the IEC C20 plug or IEC C22 plug, as shown in FIG. 2.

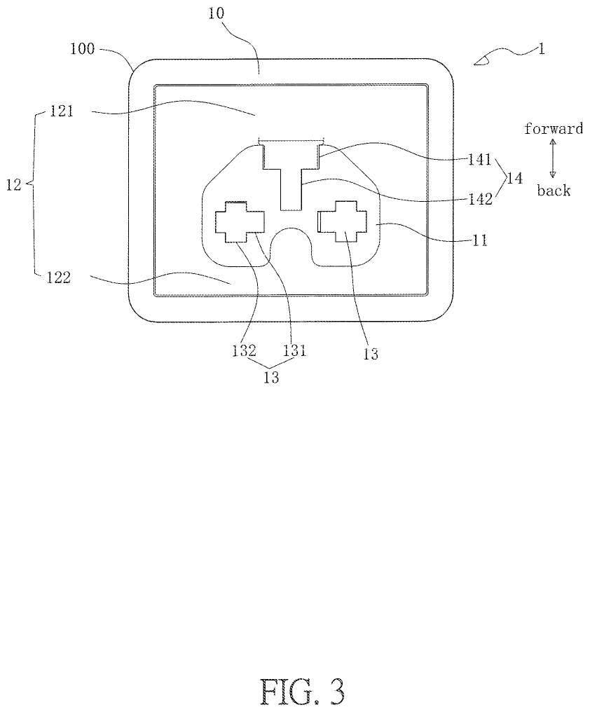

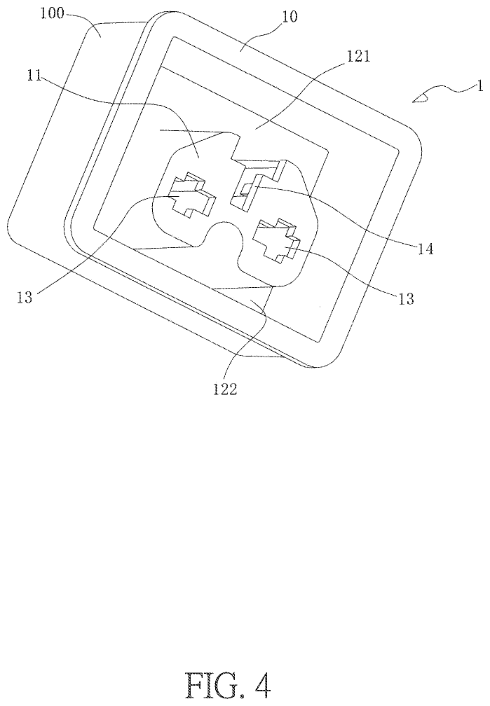

As shown in FIGS. 3-4, the socket face 10 on the casing 100 of this combination socket 1 has a recessed groove 12, socket core 11, and socket holes. The groove 12 refers to the area depressed along the edge of the socket face 10, which accommodates the first plug 2 or the second plug 3 for insertion, thus accommodating the first plug 2 or the second plug 3. The area surrounded by the groove 12 is the socket core 11.

The surface of the socket core 11 also has three socket holes, namely a live wire socket hole, a neutral wire socket hole, and a ground wire socket hole 14. The positions of the three socket holes correspond to the conductive pins of the first plug 2 and the second plug 3. Below the socket holes, there are conductive contact pieces that can engage the conductive pins of the first plug 2 or the second plug 3.

This invention makes improvements to the groove 12 and live wire socket hole, neutral wire socket hole, specifically as follows: Both the live wire socket hole and the neutral wire socket hole are cross-shaped socket holes 13 formed by superimposing a vertical rectangular hole 132 and a horizontal rectangular hole 131. The neutral wire socket hole is symmetrically distributed with the live wire socket hole.

As shown in FIGS. 3-5, the groove 12 is set to be different from the spacing size of the socket core 11. Specifically, the groove 12 surrounding the socket core 11 has different widths due to different positions. Looking down at the socket face 10, the ground wire socket hole 14 faces forward, the groove size at the front of the socket core 10 is wider, known as the wide groove, and the groove size at the back of the socket core 11 is narrower, known as the narrow groove. That is to say, the groove 12 includes the wide groove 121 in front of the socket core 11 and the narrow groove 122 at the back of the socket core 11. The narrow groove 122 serves as a positioning guide for the first plug 2 and the second plug 3 during insertion, and the width of the narrow groove 122 fits the thickness of the insulating wall 21 of the first plug 2 and the insulating wall 31 of the second plug 3, effectively restricting the degree of freedom of the first and second plugs to sway. When the first plug 2 is inserted into the socket core 11, the narrow groove 122 fits the insulating wall 21 of the first plug 2, allowing the first plug 2 to slide in, the conductive pins of the first plug 2 enter from the vertical rectangular hole 132, and the narrow groove 122 fastens the insulating wall 21 of the first plug 2. When the second plug 3 is inserted into the socket core 11, the narrow groove 122 cooperates with the insulating wall 31 of the second plug 3, allowing the second plug 3 to slide in, the conductive pins of the second plug 3 enter from the horizontal rectangular hole 131, and the narrow groove 122 fastens the insulating wall 31 of the second plug 3.

In other words, the narrow groove 122 can guide the insulation wall 21 of the first plug 2 and the insulation wall 31 of the second plug 3 to insert, and can locate the insulation wall 21 of the first plug 2 and the insulation wall 31 of the second plug 3, realizing tight matching for different plugs inserted (i.e., the first plug 2 and the second plug 3), without the need to add independent anti-detachment parts. This would not increase manufacturing costs, and it's also convenient for assembly and use, thus resolving the first shortcoming in the prior art.

The conductive contact pieces below the live wire socket hole and the neutral wire socket hole are all referred to as live-neutral wire conductive contact pieces 15. The conductive pins in the first plug 2 corresponding to the live wire socket hole and the neutral wire socket hole are all referred to as live-neutral wire conductive pins 22; The conductive pins in the second plug 3 corresponding to the live wire socket hole and the neutral wire socket hole are all referred to as live-neutral wire conductive pins 32.

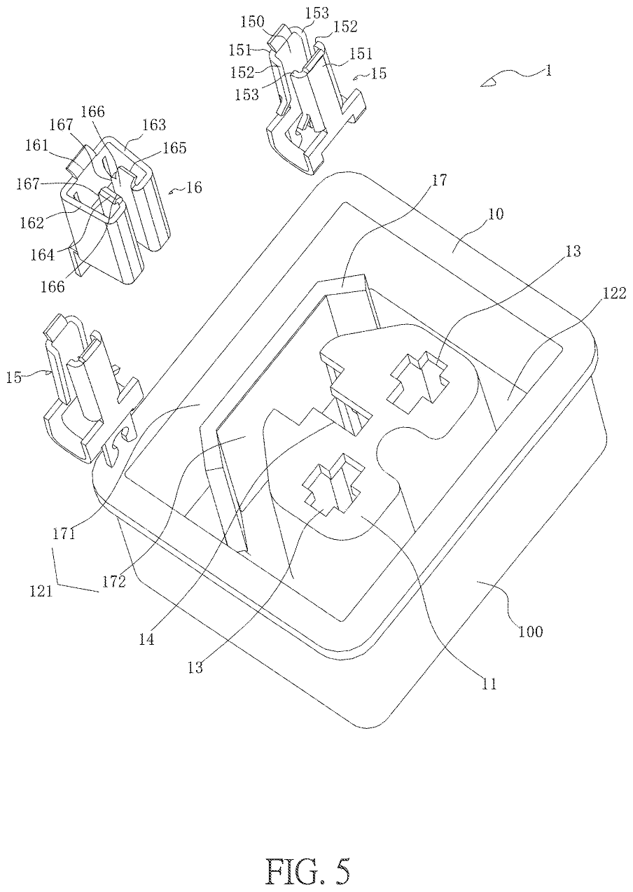

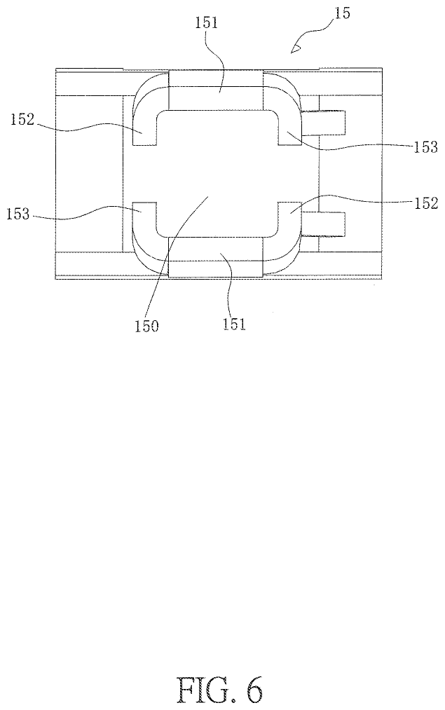

As shown in FIGS. 5-6, the upper part of the live-neutral wire conductive contact piece 15 has two opposing U-shaped contact pieces 151, which are vertically oriented. Each U-shaped contact piece 151 has a curved part on both sides referred to as the left wing 152 and the right wing 153, which serve as reinforcements to increase the clamping force of the two opposing U-shaped contact pieces 151, thereby enhancing the stability of conduction; A sleeve 150 is formed in the middle of the left wing 152 and the right wing 153 of the two opposing U-shaped contact pieces 151. A first gap is formed by the left wing 152 of one U-shaped contact piece 151 opposing the right wing 153 of another U-shaped contact piece 151, and a second gap is formed by the right wing 153 of one U-shaped contact piece 151 opposing the left wing 152 of another U-shaped contact piece 151. These first and second gaps can accommodate the insertion of the live-neutral wire conductive pin 32 of the second plug 3, and are clamped by the left wing 152 and the right wing 153 of the two U-shaped contact pieces 151 simultaneously, forming four contact points, resulting in high contact stability and enhanced current carrying capacity. The sleeve 150 can accommodate the insertion of the live-neutral wire conductive pin 22 of the first plug 2, and it clamps the live-neutral wire conductive pin 22 of the first plug 2. This composite socket design, with consideration for the shape of the socket hole and high elasticity multi-contact point live-neutral wire conductive contact piece design, can completely improve the design shortcomings of patent CN211428413U, without increasing manufacturing costs. In other words, it can solve the second shortcoming of the prior art.

The conductive contact piece below the ground wire socket hole 14 is called the ground wire conductive contact piece 16, and the conductive pins in the first plug 2 and the second plug 3 corresponding to the ground wire socket hole 14 are referred to as the ground wire conductive pins 23, 33.

As shown in FIGS. 3-5, a vertical rectangular hole 142 is opened in the socket core 11, which corresponds in position and size to the ground wire conductive pin 23 of the first plug 2. Also, the socket core 11 opens a horizontal rectangular hole 141, which corresponds in position and size to the ground wire conductive pin 33 of the second plug 3. The vertical rectangular hole 142 and the horizontal rectangular hole 141 together form a T-shaped ground wire socket hole 14.

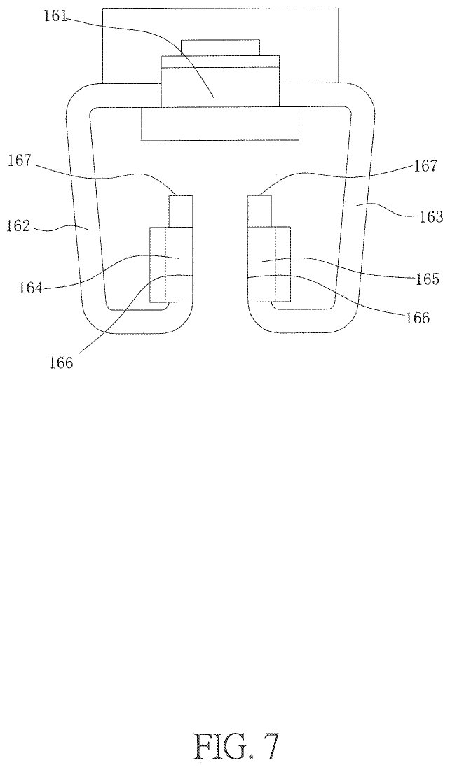

As shown in FIGS. 5 and 7, the ground wire conductive contact piece 16 has a central arm 161, a left wing arm 162 and a right wing arm 163 which are formed by bending the two ends of the central arm 161 and are distributed opposingly, and left and right clamping arms 164 and 165 which are formed by inward bending of the side surfaces of the left wing arm 162 and the right wing arm 163 and are distributed opposingly. The opposing surfaces of the left and right clamping arms 164 and 165 are referred to as the clamping arm front face 166, and the surfaces of the left and right clamping arms 164 and 165 opposite the central arm 161 are referred to as the clamping arm knife face 167. When the first plug 2 is inserted into the socket core, the clamping arm front face 166 of the left and right clamping arms 164 and 165 clamps the ground wire conductive pin of the first plug 2, and the central arm 161 also contacts another side of this ground wire conductive pin 23, making the ground wire conductive contact piece 16 and the ground wire conductive pin 23 form a three-sided contact to increase the current of conduction. When the second plug 3 is inserted into the socket core 11, the central arm 161 and the clamping arm knife face 167 of the left and right clamping arms 164 and 165 clamp the ground wire conductive pin 33 of the second plug 3, making the ground wire conductive contact piece 16 and the ground wire conductive pin 33 also form a three-sided contact to increase the current of conduction.

As shown in FIG. 5, the area adjacent to the ground wire socket hole 14 and the wide groove 121 is designed as an opening, allowing the ground wire socket hole 14 to communicate with the wide groove 121. This creates sufficient space for the deformation of the central arm 161. In other words, designing an opening at the intersection of the ground wire socket hole 14 and the wide groove 121 provides better flexibility for the deformation of the central arm 161 when the ground wire conductive pins 23, 33 are inserted. This design can enhance the elasticity of the central arm 161, ensuring the stability of the contact between the ground wire conductive contact piece 16 and the ground wire conductive pins 23, 33. It also facilitates the insertion of ground wire conductive pins 23, 33. After the ground wire conductive pins 23, 33 are unplugged, the ground wire conductive contact piece 16 can completely rebound, enhancing the durability and service life.

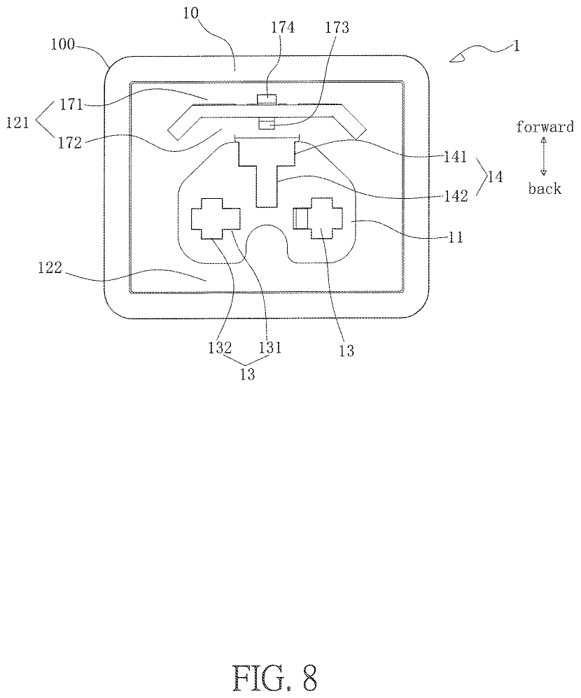

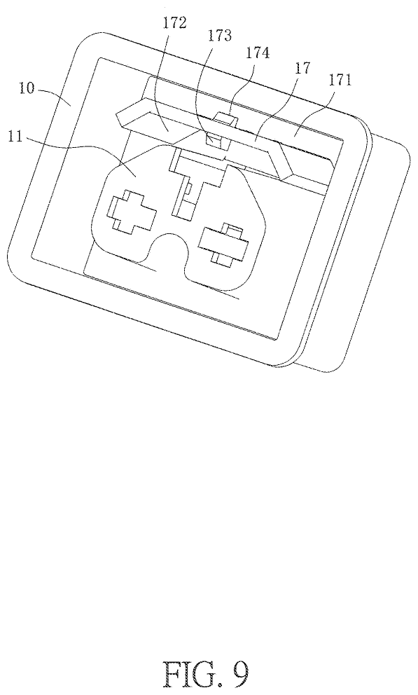

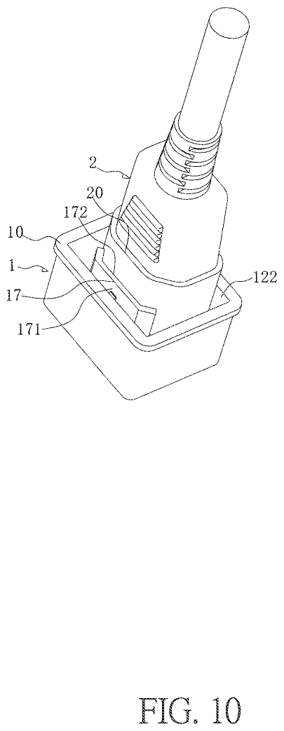

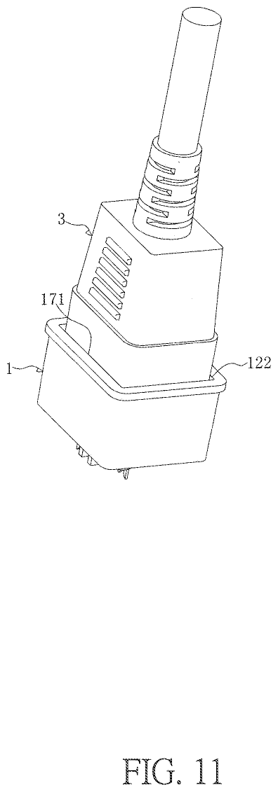

As shown in FIGS. 8-9, the bottom of the wide groove 121 is provided with a vertical wall 17. Specifically, the vertical wall 17 is integrally molded at the bottom of the wide groove 121 and extends vertically upward. The vertical wall 17 divides the wide groove 121 into a front groove 171 and a rear groove 172. The width of the front groove 171 matches the thickness of the insulation wall 31 of the second plug 3, and the width of the rear groove 172 matches the thickness of the insulation wall 21 of the first plug 2. When the first plug 2 is inserted into the socket core 11, as shown in FIG. 10, the rear groove 172 and the narrow groove guide the first plug 2 into the socket core 11, and the rear side of the vertical wall 17 is on the outer perimeter of the insulation wall 21 of the first plug 2, tightening the first plug 2 and further enhancing the fastening degree of the first plug 2 inserted into the socket core 11. When the second plug 3 is inserted into the socket core 11, as shown in FIG. 11, the front groove 171 and the narrow groove guide the second plug 3 into the socket core 11, and the front side of the vertical wall 17 is inside the insulation wall 31 of the second plug 3, tightening the second plug 3 and further enhancing the fastening degree of the second plug 3 inserted into the socket core 11.

Furthermore, as shown in FIGS. 8-9, one or more rear protrusions 173 are set on the rear side of the vertical wall 17, and a chamfer or fillet, which allows the insertion of the insulation wall of the first plug 2, is set above the rear protrusion 173. This chamfer or fillet plays a guiding role and can smoothly guide the first plug 2. When the first plug 2 is inserted into the socket core 11, the vertical wall 17 is on the outside of the insulation wall 21 of the first plug 2, and the rear protrusion 173 tightly attaches to the outer side of the insulation wall 21 of the first plug 2, further enhancing the fastening degree of the first plug 2 inserted into the socket core 11.

As shown in FIGS. 8-9, one or more front protrusions 174 are set on the front side of the vertical wall 17, and a chamfer or fillet, which allows the insertion of the insulation wall of the second plug 3, is set above the front protrusion 174. This chamfer or fillet also plays a guiding role and can smoothly guide the second plug 3. When the second plug 3 is inserted into the socket core 11, the vertical wall 17 is on the inside of the insulation wall 31 of the second plug 3, and the front protrusion 174 tightly attaches to the inside of the insulation wall 31 of the second plug 3, further enhancing the fastening degree of the second plug 3 inserted into the socket core 11.

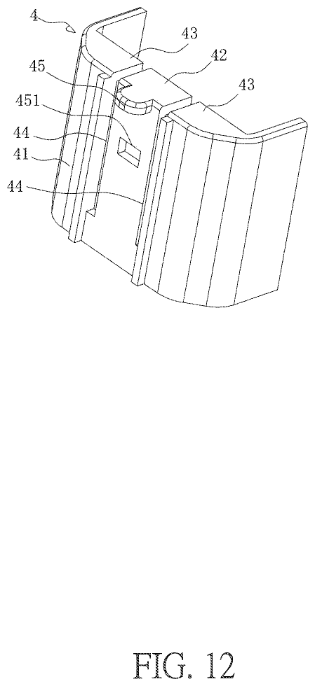

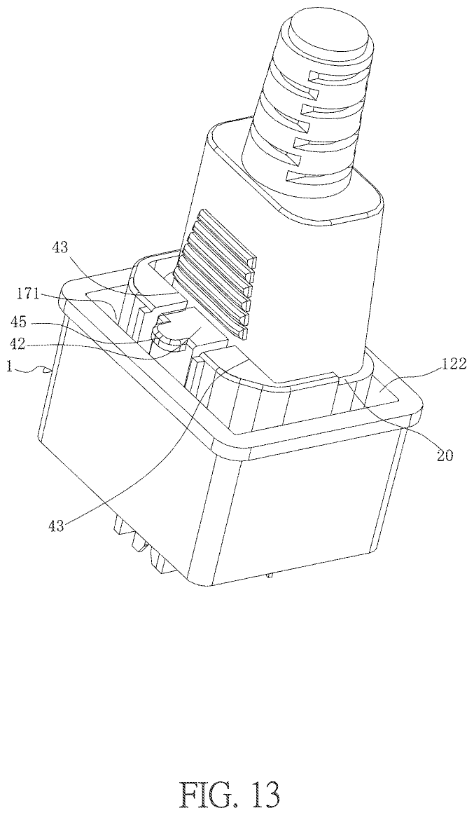

To prevent the disconnection of the first plug 2 from the combined socket 1 due to the pulling of the equipment power cord, an independent lock cover 4 has been designed, as shown in FIGS. 12-13. The lock cover 4 is a semi-enclosed structure, with a flat body 41, an unlock button 42 and a protruding eave 43 on top. On both sides of the unlock button 42, there is a downward groove 44, forming a swingable connecting rod 45 underneath the unlock button 42. An opening 451 is set on this connecting rod 45. When the first plug 2 is inserted into the socket core 11, the flat body 41 of the lock cover 4 is inserted into the front groove 171, the protruding eave 43 covers the platform 20 of the first plug 2, and the opening 451 of the connecting rod 45 is buckled with the front protrusion 174 of the vertical wall 17, fixing the first plug 2 in the inserted position. When the unlock button 42 is pushed forward, the opening 451 is detached from the front protrusion 174 on the vertical wall 17, effectively preventing the first plug 2 from disconnecting from the combined socket 1.

In summary, the invention divides the groove 12 into the wide groove 121 and narrow groove 122 of different sizes, and sets the live wire socket hole and neutral wire socket hole as cross socket holes 13. The narrow groove 122 acts as the positioning guide when the first plug 2 and the second plug 3 are inserted, and the width of the narrow groove 122 fits with the thickness of the insulating wall 21 of the first plug 2 and the insulating wall 31 of the second plug 3. The narrow groove 122 can guide the insertion of the insulating wall 21 of the first plug 2 and the insulating wall 31 of the second plug 3, and position them, realizing the close fit of different plugs (i.e., the first plug 2 and the second plug 3) inserted without the need for independent anti-detachment parts, which does not increase manufacturing cost and is easy to assemble and use. The invention sets the upper end of the live neutral line conductive contact piece as two opposite U-shaped contact pieces 151. The left and right wings of the two U-shaped contact pieces 15 serve as conductive contact points and strengthen the holding force. Not only can it enhance the holding force, but it can also clamp the live neutral line conductive needle 32 of the second plug 3 to form four contact points to enhance the conductive current capacity. The socket 150 formed between the two opposing U-shaped contact pieces 151 allows the insertion of the live neutral line conductive needle 22 of the first plug 2 and clamps the live neutral line conductive needle 22 of the first plug 2 to ensure the stability of conduction. The invention sets the ground wire socket hole 14 to communicate with the wide groove 121, so that the central arm 161 has better deformability when the ground wire conductive needle 23, 33 is inserted, so that the ground wire conductive needle 23, 33 is easier to insert, and after the ground wire conductive needle 23, 33 is pulled out, the ground wire conductive contact piece 16 rebounds completely, which can ensure the durability of use and extend the service life. The invention also has an independent lock cover for the combined socket to prevent the phenomenon that the power cord of some equipment pulls and causes the first plug to exit the socket core.

Of course, the above descriptions are only specific embodiments of this invention, and are not intended to limit the scope of this invention. Any equivalent changes or modifications made according to the structure, characteristics, and principles described in the patent application scope of this invention should be included in the patent application scope of this invention.

I claim:

1. A combination socket, having a socket surface adaptable to various different specifications of IEC plugs, the socket surface is on a shell of this combination socket and has a recessed groove, a socket core, and a socket hole, a recessed area along an edge of the socket surface is set as a groove, and an area surrounded by the groove is the socket core; the surface of the socket core also has three socket holes, respectively, a live wire socket hole, a neutral wire socket hole, and a ground wire socket hole; the positions of the three socket holes correspond to conductive pins of a first plug and a second plug, and underneath the socket holes are conductive contact pieces that can bite into the conductive pins of the first plug or the second plug, characterized in that:
wherein the groove includes a wide groove in front of the socket core and a narrow groove behind the socket core; the narrow groove serves as a positioning guide groove for the insertion of the first plug and the second plug, and the width of the narrow groove matches the thickness of an insulation wall of the first plug and the second plug; the live wire socket hole and neutral wire socket hole are both cross-shaped socket holes formed by vertically stacking a vertical rectangle hole and a horizontal rectangle hole; the neutral wire socket hole and live wire socket hole are symmetrically distributed; the cross-sectional area of a conductive pin of the first plug is a vertical rectangle, which belongs to an IEC C14 plug or an IEC C16 plug; the cross-sectional area of a conductive pin of the second plug is a horizontal rectangle, which belongs to an IEC C20 plug or an IEC C22 plug; when the first plug is inserted into the socket core, the narrow groove matches the insulation wall of the first plug, making the first plug go in smoothly, and the conductive pin of the first plug inserts from the vertical rectangle hole, and the narrow groove tightens the insulation wall of the first plug; when the second plug is inserted into the socket core, the narrow groove matches the insulation wall of the second plug, making the second plug go in smoothly, and the conductive pin of the second plug inserts from the horizontal rectangle hole, and the narrow groove tightens the insulation wall of the second plug.

2. The combination socket as claimed in claim 1, wherein the conductive contact pieces under the live wire socket hole and neutral wire socket hole are all called live-neutral wire conductive contact pieces, the conductive pins in the first plug and second plug corresponding to the live wire socket hole and neutral wire socket hole are called live-neutral wire conductive pins; the upper part of the live-neutral wire conductive contact piece has two opposite U-shaped contact pieces, in which, the bent parts on both sides of each U-shaped contact piece are called a left wing and a right wing, these left wing and right wing act as reinforcing ribs to increase the clamping force of the two opposite U-shaped contact pieces; a sleeve is formed in the middle of the left wing and right wing of the two opposite U-shaped contact pieces, one left wing of a U-shaped contact piece and the right wing of another U-shaped contact piece are opposite and form a first gap, one right wing of a U-shaped contact piece and the left wing of another U-shaped contact piece are opposite and form a second gap, this first gap and the second gap allow the live-neutral wire conductive pin of the second plug to insert, and the left wing and right wing of the two U-shaped contact pieces simultaneously clamp this live-neutral wire conductive pin of the second plug and form four contact points; and the sleeve allows the live-neutral wire conductive pin of the first plug to insert, and the sleeve clamps the live-neutral wire conductive pin of the first plug.

3. The combination socket according to claim 1, wherein the conductive contact piece below the ground socket hole is referred to as the ground conductive contact piece, the conductive pins in the first plug and the second plug corresponding to the ground socket hole are referred to as ground conductive pins; a vertically rectangular hole is opened in the socket core, its position and size corresponding to the ground conductive pin of the first plug, and another horizontally rectangular hole is opened in the socket core, its position and size corresponding to the ground conductive pin of the second plug, with the vertically rectangular hole and horizontally rectangular hole overlapped to form a T-shaped ground socket hole; the ground conductive contact piece includes a central arm, left and right wing arms bent from both ends of the central arm and facing each other, and left and right clamp arms bent inward from the sides of the left and right wing arms and facing each other, where the faces of the left and right clamp arms that are opposite each other are referred to as the front faces of the clamp arms, and the faces of the left and right clamp arms opposite to the central arm are referred to as the blade faces of the clamp arms; when the first plug is inserted into the socket core, the front faces of the left and right clamp arms hold the ground conductive pin of the first plug, and the central arm also touches the other side of this ground conductive pin, allowing the ground conductive contact piece to form a three-sided contact with the ground conductive pin to increase the current flow; when the second plug is inserted into the socket core, the central arm and the blade faces of the left and right clamp arms hold the ground conductive pin of the second plug, enabling the ground conductive contact piece to also form a three-sided contact with the ground conductive pin.

4. The combination socket according to claim 3, wherein the ground socket hole is opened adjacent to the wide groove, making the ground socket hole communicate with the wide groove, thus forming enough space for the central arm to deform.

5. The combined socket according to claim 1, wherein a vertical wall is installed at the bottom of the wide groove, dividing the wide groove into a front groove and a rear groove, where the width of the front groove is designed to match the insulation wall thickness of the second plug, and the width of the rear groove is designed to match the insulation wall thickness of the first plug; when the first plug is inserted into the socket core, the rear groove and the narrow groove guide the first plug into the socket core, with the rear side wall of the vertical wall around the insulation wall of the first plug, thereby securing the first plug; when the second plug is inserted into the socket core, the front groove and the narrow groove guide the second plug into the socket core, with the front side wall of the vertical wall inside the insulation wall of the second plug, thereby securing the second plug.

6. The combination socket according to claim 5, wherein one or more rearward protrusions are installed on the rear side wall of the vertical wall, the top of the rearward protrusions features a lead-in angle or a rounded corner allowing the insulation wall of the first plug to be inserted; when the first plug is inserted into the socket core, the vertical wall is outside the insulation wall of the first plug, and the rearward protrusion is closely fitted with the outside of the insulation wall of the first plug to secure the first plug.

7. The combination socket according to claim 5, wherein one or more forward protrusions are installed on the front side wall of the vertical wall, the top of the forward protrusions features a lead-in angle or a rounded corner allowing the insulation wall of the second plug to be inserted; when the second plug is inserted into the socket core, the vertical wall is inside the insulation wall of the second plug, and the forward protrusion is closely fitted with the inside of the insulation wall of the second plug to secure the second plug.

8. The combination socket as claimed in claim 5, wherein a lock cover independent from the combination socket features a semi-enclosed structure; said lock cover comprises a flat body, an unlocking button, and a protruding eave on the upper part; each side of the unlocking button includes a downward groove, forming a swingable connecting arm below the unlocking button, further equipped with an opening; when the first plug is inserted into the socket core, the flat body of the lock cover is inserted into the front groove, with the protruding eave covering the protrusion on the first plug; the opening on the connecting arm engages with the forward protrusion on the vertical wall, securing the first plug in its inserted position; when the unlocking button is pushed forward, the opening disengages from the forward protrusion on the vertical wall.
